(19) United States
(12) Patent Application Publication
(10) Pub. No.: US 2021/0248703 A1
(43) Pub. Date: Aug. 12, 2021

(54) Methods and Systems for Detecting Inmate Communication Anomalies in a Correctional Facility

(71) Applicant: Motorola Solutions, Inc., Chicago, IL (US)

(72) Inventors: Chad Esplin, Mendon, UT (US); Yujing Su, Chicago, IL (US); Veerapriya Veerasubramanian, Chicago, IL (US)

(21) Appl. No.: 16/789,226

(22) Filed: Feb. 12, 2020

(51) Int. Cl. G06Q 50/26; G06N 20/00; G06N 5/04; G06F 40/279; G08B 21/02; G06F 40/30

(52) U.S. Cl. CPC G06Q 50/265; G06N 20/00; G06F 40/30; G06F 40/279; G08B 21/02; G06N 5/04

(57) ABSTRACT

An analysis engine of an anomaly detection system receives a communication associated with an inmate in a correctional facility, evaluates a keyword identified within the communication using an anomaly detection model, and determines whether the keyword is an anomaly indicating a potential activity associated with the inmate. In response to determining that the keyword is an anomaly, the analysis engine generates an alert for the anomaly, determines an authority to notify, and notifies the authority with the generated alert. The analysis engine may receive a feedback rating for the anomaly and may update the anomaly detection model using the feedback rating. In this way the accuracy of the anomaly detection system may be improved over time. The anomaly detection models may include general data, inmate-specific data, and parameters associated with the data. The parameters associated with the data may include a weight parameter or a threshold value.

### BACKGROUND OF THE INVENTION

Monitoring the large number of communications between inmates in a correctional facility and people outside the correctional facility is important in order to detect and prevent criminal activities and safety issues. Examples include planned escapes, suicides, witness intimidation, victim retaliation, evidence tampering, and the like. Communications by an inmate may be in the form of postal mail, email, video conferences, phone calls, and the like. Certain keywords in a communication by an inmate may indicate a potential criminal activity, safety issue, or both associated with the inmate, and such keywords identified in a communication may be referred to as anomalies. Although many inmate communications are recorded, inmate communications are not monitored at or near the time the communication occurs, and often are never monitored at all. In some correctional facilities, less than 5% of communications between inmates and people outside the correctional facility are monitored. If anomalies in communications associated with inmates in correctional facilities could be reliably detected and appropriate authorities notified with sufficient time to intervene, potential criminal activities and safety issues could be prevented.

Accordingly, there is a need for methods and systems for detecting inmate communication anomalies in a correctional facility.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a block diagram illustrating selected elements of anomaly detection models for different inmates, in accordance with some embodiments.

FIG. 2 is a block diagram illustrating selected elements of an example anomaly detection system, in accordance with some embodiments.

FIG. 3A is a flowchart illustrating selected elements of an example method for detecting anomalies in an inmate communication and notifying an authority, in accordance with some embodiments.

FIG. 3B is a flowchart illustrating selected elements of an example method for determining an authority to notify, in accordance with some embodiments.

FIG. 4 is a flowchart illustrating selected elements of an example method for detecting anomalies in an inmate communication and updating an anomaly detection model with feedback received from a notified authority, in accordance with some embodiments.

FIG. 5 is a block diagram illustrating selected elements of an example analysis engine, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by suitable symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Disclosed herein are methods and systems for detecting an anomaly in a communication by an inmate in a correctional facility. In one embodiment, a disclosed method for detecting inmate communication anomalies includes receiving a communication associated with an inmate in a correctional facility, evaluating a keyword identified within a text representation of the received communication using an anomaly detection model, and determining whether the keyword is an anomaly based on the evaluation, the anomaly indicating a potential activity associated with the inmate. The method also includes, in response to determining that the keyword is an anomaly, generating an alert for the anomaly, determining an authority to notify, and notifying the authority using the generated alert.

In one embodiment, a disclosed system for detecting inmate communication anomalies includes a monitoring device to capture a communication by an inmate in a correctional facility, a non-volatile memory to store an anomaly detection model, and an analysis engine communicatively coupled to the non-volatile memory. The analysis engine includes a first input to receive the captured communication from the monitoring device and a processor configured to evaluate a keyword identified within a text representation of the communication, the evaluation using the anomaly detection model, and determine whether the keyword is an anomaly based on the evaluation, the anomaly indicating a potential activity associated with the inmate. In response to determining that the keyword is an anomaly, the processor is further configured to generate an alert for the anomaly, determine an authority to notify, and notify the authority using the generated alert. The system also includes an output to notify the authority.

In one embodiment, a non-transitory, computer-readable storage medium having program instructions stored thereon is disclosed. When loaded and executed by an electronic processor, the program instructions cause the electronic processor to perform evaluating a keyword identified within a text representation of a communication associated with an inmate in a correctional facility using an anomaly detection model and determining whether the keyword is an anomaly based on the evaluation, the anomaly indicating a potential activity associated with the inmate. In response to determining that the keyword is an anomaly, the program instructions further cause the electronic processor to perform generating an alert for the anomaly, determining an authority to notify, and notifying the authority using the generated alert.

In any of the disclosed embodiments, the potential activity associated with the inmate may correspond to a crime, a safety issue, or both. In any of the disclosed embodiments, the keyword identified within a text representation of an inmate communication may be evaluated in real-time to a transmission of the communication.

In any of the disclosed embodiments, determining an authority to notify may comprise determining that the potential activity associated with the inmate relates to an activity outside of the correctional facility, and identifying an authority outside of the correctional facility to notify.

In any of the disclosed embodiments, the anomaly detection model may further comprise inmate-specific data associated with the inmate. The inmate-specific data may comprise a criminal record, a name of a person associated with a criminal offense associated with the inmate, or both. The anomaly detection model may further comprise general data, the general data associated with a plurality of inmates, wherein the plurality of inmates comprises the inmate. As used herein, inmate-specific data refers to information that is specific to an individual inmate. As used herein, general data refers to information that is not specific to a single inmate and is applicable to, and may be associated with, many or all inmates in one or more correctional facilities. In some embodiments, a piece of information may be both inmate-specific data and general data.

In any of the disclosed embodiments, the method may further comprise receiving a feedback rating for the anomaly in response to notifying the authority using the generated alert and updating the anomaly detection model using the received feedback rating. The anomaly detection model may comprise a parameter and updating the anomaly detection model using the received feedback rating may comprise adjusting the parameter of the anomaly detection model. Parameters may include, but are not limited to, point values, multiplication factors, and threshold values. In some embodiments, a parameter may provide a weight for the evaluation of a keyword. The anomaly detection model may further comprise inmate-specific data associated with the inmate, and the parameter may be associated with the inmate-specific data. The anomaly detection model may further comprise general data, the general data associated with a plurality of inmates, wherein the plurality of inmates comprises the inmate, and the parameter may be associated with the general data.

As noted above, there are a large number of inmate communications in correctional facilities. Inmate communications may include phone conversations, video conferences, emails, postal communications, and the like. In various embodiments, the methods and systems described herein may be used to detect anomalies in inmate communications. As used herein, an anomaly may be keyword or combination of keywords identified within an inmate communication that indicates a potential activity associated with an inmate. As used herein, a keyword may be a single word or a combination of words. When an authority is notified of the anomaly, the authority may want to take action to prevent or otherwise respond to the potential activity associated with the inmate. Such potential activities may also be referred to as potential activities of interest. As used herein, a potential activity associated with an inmate may refer to potential past, present, or future activity, or any suitable combination thereof. In some embodiments, the potential activity may indicate a suspicious or dangerous activity, for example, a criminal activity, a potential safety issue, or any suitable combination thereof. What constitutes a potential criminal activity may be determined based on criminal codes in the relevant jurisdictions at the time a keyword identified within an inmate communication is being evaluated. Examples of a potential safety issue may include self-harm, suicide, and harm to others. In some embodiments, an anomaly may indicate both a potential crime and safety issue.

In some embodiments, nonsensical speech identified within an inmate communication may be identified as a keyword and determined to be an anomaly indicating, for example, that the inmate is engaging in the potential activity of coded communications. In some embodiments, machine learning or other artificial intelligence techniques may be used to determine that a string of text identified within an inmate communication is nonsensical speech. Upon determining that the nonsensical speech may be potential coded speech, an anomaly detection system may attempt to break the coded speech. For example, by using machine learning or other artificial intelligence techniques to compare the coded speech to other communications associated with the inmate to identify patterns within the communications indicating that certain nonsensical words are being used as a substitute for other words. In some embodiments, other code breaking techniques may be used by the anomaly detection system.

In order for an authority to take action to prevent a potential activity of interest from occurring, the authority may be notified with sufficient time to act on the information. In some embodiments, inmate communications may be evaluated in real-time using the methods and systems disclosed herein. What constitutes real-time may depend on the type of communication being evaluated. For example, an evaluation of a phone conversation or a video conference may be considered real-time when the evaluation occurs during or shortly after the phone conversation or video conference. As another example, an evaluation of a postal communication may be considered real-time when the evaluation occurs before or shortly after the postal communication is sent or before or shortly after the postal communication is delivered to the intended recipient. When a postal communication is intercepted and evaluated before it is delivered to a recipient, that may be considered real-time. As used herein, real-time may be relative to a transmission of an inmate communication. What constitutes a transmission of an inmate communication may vary based on the type of communication. For example, a transmission of a phone conversation may occur while the phone conversation is taking place. As another example, a transmission of a postal communication may occur while the postal communication is in transit from a sender to an intended recipient. In some embodiments, a communication may be evaluated in real-time when it is evaluated while the communication is being transmitted to or from an inmate, or within close temporal proximity to an original transmission of the communication to an intended recipient. In some embodiments, real-time may include a temporal delay of up to 1 hour between the completion of a transmission of a communication and the evaluation of a keyword identified within the communication.

In at least some embodiments, the techniques described herein for detecting inmate communication anomalies may be applied in systems that implement anomaly detection using unsupervised machine learning. For example, unsupervised anomaly detection techniques may operate under an assumption that the majority of instances of an identified keyword or keywords, such as an inmate in a correctional facility discussing feelings of depression in a captured communication with a family member on the outside of the correctional facility, an inmate discussing details of the criminal offense for which the inmate was incarcerated in a captured communication, or an inmate discussing interactions with other inmates in a captured communication in an unlabeled data set should not be classified as anomalies and may classify as anomalies those instances that appear to be outliers compared to the majority of the instances. In other embodiments, these techniques may be applied in anomaly detection systems that employ supervised machine learning or other artificial intelligence techniques. Supervised anomaly detection techniques may involve training a classifier, which may involve labeling elements, such as a keyword or combination of keywords, of a training data set as representing an anomaly or as representing a normal or typical occurrence. Machine learning techniques that may be used in the anomaly detection systems described herein may include, but are not limited to, Linear Regression techniques, Logistic Regression techniques, Decision Trees, SVM, Naive Bayes techniques, k-nearest neighbor techniques, K-Means clustering, Random Decision Forest techniques, Dimensionality Reduction Algorithms, various Gradient Boosting algorithms, such as Gradient Boosting Machine techniques, Extreme Gradient Boosting algorithms, Light Gradient Boosting Machine algorithms, or Gradient Boosting algorithms with categorical features, Apriori algorithms, Markov Decision Processes, and various neural networks, such as Feedforward Neural Networks, Artificial Neuron Models, Radial Basis Function Neural Networks, Multilayer Perceptron Networks, Convolutional Neural Networks, Deep Convolutional Neural Networks, Deconvolutional Neural Networks, Deep Convolutional Inverse Graphics Networks, Generative Adversarial Networks, Recurrent Neural Networks, Long/Short Term Memory techniques, Modular Neural Networks, Sequence-To-Sequence Models, Liquid State Machines, Extreme Learning Machines, Deep Residual Networks, Kohonen Networks, Support Vector Machines, or Neural Turing Machines.

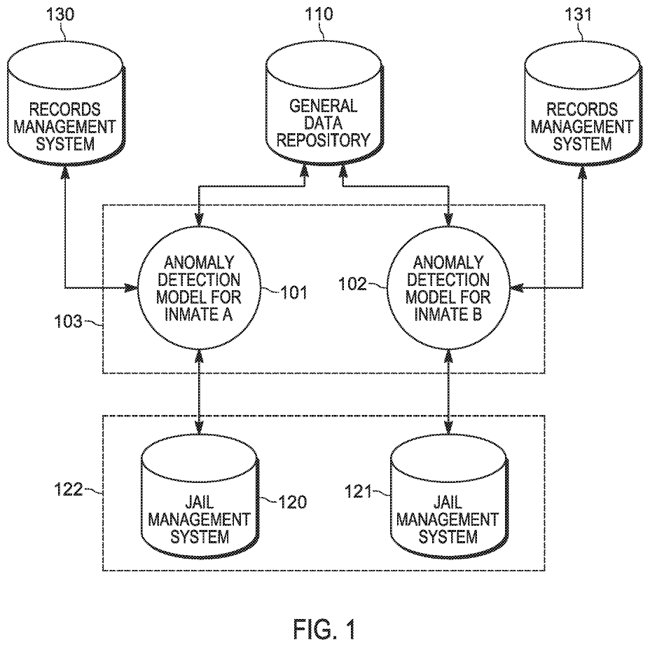

Referring now to FIG. 1, there is provided a block diagram illustrating selected elements associated with example anomaly detection models for different inmates in a correctional facility. Preferably, each inmate in a correctional facility will have a unique anomaly detection model. For example, anomaly detection model 101 may be for Inmate A, and anomaly detection model 102 may be for Inmate B. The anomaly detection models may be stored together, as indicated by dashed line 103, in a single anomaly detection model repository (not shown in FIG. 1). However, in some embodiments, any suitable number of anomaly detection models for different inmates may be stored in any number of different repositories.

In some embodiments, the anomaly detection models 101 and 102 each include general data from general data repository 110. For example, general data may include common keywords that may indicate suspicious or dangerous actions or emotions (e.g., ‘hurt’, ‘suicide’, ‘waste’, ‘delete’, and the like). Other examples may include common slang terms (e.g., “special K” for ketamine). In some embodiments, general data repository 110 may be a database containing common keywords. The information in general data repository 110 may be updated over time based on patterns identified in the communications of multiple inmates. The patterns may be identified, for example, through the use of machine learning or other artificial intelligence techniques used by the anomaly detection systems described herein. For example, inmates may use specific slang terms that are not part of normal speech, which may be sometimes referred to as jail slang or prison slang, to refer to certain things or people, including but not limited to contraband, other inmates, and guards. For example, in one or more correctional facilities, cigarettes may be referred to as “bats,” another inmate with whom an inmate is breaking the rules may be referred to as an “associate,” a small package of drugs may be referred to as a “bundle,” and the like. The slang terms used by inmates in correctional facilities may be different between multiple correctional facilities and are subject to change over time. In some embodiments, machine learning or other artificial intelligence techniques may be used to monitor many or all inmate communications to identify trends indicating that new slang terms are being used by multiple inmates and to update the general data in general data repository 110 accordingly.

In some embodiments, the anomaly detection models 101 and 102 include inmate-specific data. For example, anomaly detection model 101 may include inmate-specific data that is specific to Inmate A, while anomaly detection model 102 may include inmate-specific data that is specific to Inmate B. There may be various sources of inmate-specific data. For example, records management system (RMS) data may include, but is not limited to, the names of a victim, a witness, a co-defendant, a cell mate, a responsible pod officer, and the like. As another example, jail management system (JMS) data may include information regarding incidents within a correctional facility, disciplinary actions, and other correctional facility records. Anomaly detection model 101 may include inmate-specific data for Inmate A from jail management system 120. Anomaly detection model 102 may include inmate-specific data for Inmate B from jail management system 121. In some embodiments, jail management systems 120 and 121 may be part a unified jail management system as indicated by dashed line 122. For example, jail management systems 120 and 121 may be part a unified jail management system when Inmate A and Inmate B are incarcerated in the same correctional facility. In other embodiments jail management systems 120 and 121 may be separate jail management systems. Anomaly detection model 101 may include inmate-specific data for Inmate A from records management system 130. Anomaly detection model 102 may include inmate-specific data for Inmate B from records management system 131. Again, in some embodiments, records management systems 130 and 131 may be a part of a single records management system (not shown in FIG. 1), while in other embodiments records management systems 130 and 131 may be separate. In some embodiments, inmate-specific data may be included in an inmate's anomaly detection model from other data sources. For example, computer-aided dispatch (CAD) systems may include prearrest records associated with an inmate. Prearrest records associated with the inmate may include, but are not limited to, the name of an officer responding to a 911 call, recordings or transcripts of police radio traffic relating to a criminal offense associated with an inmate, the name of a victim associated with the inmate, the name of a witness associated with the inmate, and the like.

In some embodiments, an anomaly detection model may be a data structure adapted to include data to be used in detecting inmate communication anomalies. For example, an anomaly detection model may be a data structure adapted to include data such as general data and inmate-specific data collected from various data sources by storing the data in the anomaly detection model. As another example, an anomaly detection model may be a data structure adapted to include data by referencing data stored in various data sources, for example by using a pointer to indicate the storage location for the data. In at least some embodiments, anomaly detection model 101 or 102 may be a machine-learning model that further includes at least one parameter associated with the data included in the anomaly detection model. For example, the parameter may indicate a weight associated with data, and the weight may be used in determining whether a keyword is an anomaly. In some embodiments, the parameter may be adjusted based on feedback to train and update the anomaly detection model and improve the accuracy of the anomaly detection system over time.

In some embodiments, an anomaly detection model may be generated for an individual inmate. For example, anomaly detection model 101 for Inmate A may be generated by creating an anomaly detection model for Inmate A and populating the anomaly detection model with data from available data sources such as general data repository 110, jail management system 120, records management system 130, and the like. Other data sources may also be used, for example a computer-aided dispatch system containing records associated with the inmate. In some embodiments, machine-learning or other artificial intelligence techniques may be used to automatically populate the anomaly detection model with general data and automatically identify inmate-specific data in various data sources associated with the inmate and populate the anomaly detection model with the inmate-specific data. For example, artificial intelligence techniques may be used to search a data source, such as a records management system, for potential keywords, such as the names of witnesses or officers involved with a criminal offense associated with the inmate and populate the anomaly detection model with that data. A criminal offense associated with an inmate may be an offense for which the inmate is incarcerated or some other offense with which the inmate was involved. In some embodiments, data from a data source, such as electronic or paper records, may be manually entered to populate the anomaly detection model. Populating an anomaly detection model may include storing data from a data source in the anomaly detection model, referencing data using a pointer to indicate the location of data in a data source, or a combination of both.

In some embodiments, machine-learning techniques may be used to train an anomaly detection system. Training the anomaly detection system may include processing stored communications associated with one or more inmates and providing feedback to the system indicating whether a detected anomaly represents an accurate determination that a keyword identified within an inmate communication is an anomaly or whether a detected anomaly is a false positive. Training the system may also include providing feedback that an anomaly was not detected when one should have been detected by the system. This may be referred to as a false negative. In some embodiments, the feedback may be used to update an anomaly detection model of the anomaly detection system by, for example, adjusting a parameter of the anomaly detection model. The parameter may include, for example, a weight parameter or a threshold parameter, associated with general data or inmate-specific data included in the anomaly detection model. Additionally, feedback may be used to update an anomaly detection model by adjusting the general or inmate-specific data included in the anomaly detection model. In some embodiments, training of an anomaly detection system may continue until a satisfactory success rate, for example the percentage of detected anomalies determined to be accurate, is established for an inmate or for a segment of an inmate population. In some embodiments, a satisfactory success rate may be 70%. In some embodiments, a satisfactory success rate may be 80%. In some embodiments, a satisfactory success rate may be 85%. In some embodiments, a satisfactory success rate may be 90%. In some embodiments, a satisfactory success rate may be 95%. In some embodiments, a satisfactory success rate may be 99%. In some embodiments, a satisfactory success rate may be determined based on a statistically derived confidence level applied to a statistically relevant sample of an inmate population at one or more correctional facilities.

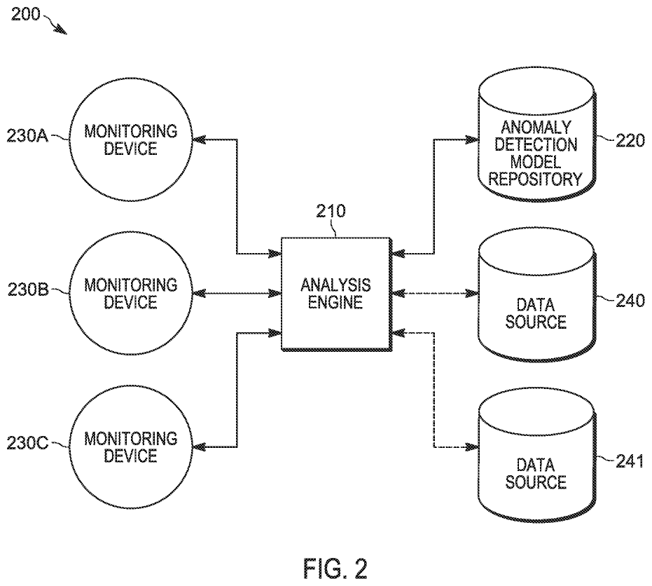

Referring now to FIG. 2, there is provided a block diagram illustrating selected elements of an example anomaly detection system 200, in accordance with some embodiments. In the illustrated example, anomaly detection system 200 includes an analysis engine 210, an anomaly detection model repository 220, and monitoring devices 230A, 230B, and 230C. In some embodiments, analysis engine 210 may be a machine-learning-based analysis engine. In some embodiments, analysis engine 210 may be a standalone electronic computing device communicatively coupled to anomaly detection model repository 220 and monitoring devices 230A, 230B, and 230C via local wired or wireless communication interfaces. In other embodiments analysis engine 210 may be, or may be a component of, a remote or cloud-based electronic computing device or server communicatively coupled to anomaly detection model repository 220 and monitoring devices 230A, 230B, and 230C over a network. Anomaly detection model repository 220 may store anomaly detection models for individual inmates, such as anomaly detection models 101 and 102 as described for FIG. 1. The anomaly detection models stored in anomaly detection model repository 220 may be used by analysis engine 210 in evaluating keywords identified in an inmate communication. The various data sources and repositories referenced herein may include non-volatile memory communicatively coupled to the analysis engine.

In some embodiments, monitoring devices 230A, 230B, and 230C may include an audio capture device, an image capture device, or a video capture device. Although three monitoring devices are shown, any suitable number of monitoring devices may be used. Those skilled in the art will appreciate that an integrated monitoring device may capture multiple aspects of one or more communications, such as audio, image, and video communications. For example, any one or all of monitoring devices 230A, 230B, and 230C may be an audio capture device that captures an audio inmate communication such as a phone call between an inmate and a person outside of the correctional facility in which the inmate is incarcerated or an audio communication between inmates within a correctional facility. Examples of audio capture devices may include, but are not limited to, microphones or electronic monitoring devices that intercept the electronic audio signal during transmission of an audio communication. In another example, any one or all of monitoring devices 230A, 230B, and 230C may be an audio/video (A/V) capture device, sometimes referred to as a video capture device, that captures a video and audio inmate communication such as a video conference between an inmate and a person outside of the correctional facility in which the inmate is incarcerated or a communication between inmates within a correctional facility. Examples of audio/video capture devices may include, but are not limited to, video cameras or electronic monitoring devices that intercept the electronic audio/video signal during transmission of a video communication. In yet another example, any one or all of monitoring devices 230A, 230B, and 230C may be an image capture device that captures an image of an inmate communication such as a written postal communication between an inmate and a person outside of the correctional facility in which the inmate is incarcerated or a written communication between inmates within a correctional facility. Examples of image capture devices may include, but are not limited to, scanners or cameras. In some embodiments, monitoring devices 230A, 230B, and 230C may contain software to generate a text representation of a captured communication. In other embodiments, analysis engine 210 may contain software to generate a text representation of a captured communication. Examples of software used to generate a text representation of a captured communication may include speech-to-text software, optical character recognition (OCR) software, and the like.

In some embodiments anomaly detection system 200 may also include data sources, represented by data sources 240 and 241, communicatively coupled to analysis engine 210. Although two data sources are shown, any suitable number of data sources may be used. Data sources 240 and 241 may be used by analysis engine 210 during the evaluation of a keyword identified within an inmate communication. For example, data sources 240 and 241 may include a data source for general data, such as general data repository 110, and data sources for inmate-specific data, such as records management systems 130 and 131 and jail management systems 120 and 121. In this way, analysis engine 210 can access data referenced by an anomaly detection model during the evaluation of an inmate communication or update an inmate's anomaly detection model when new data is included in a data source.

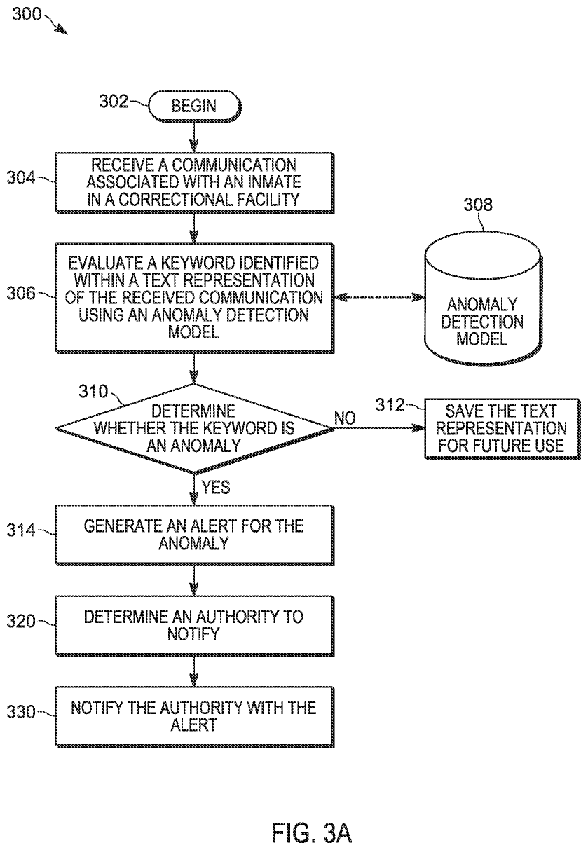

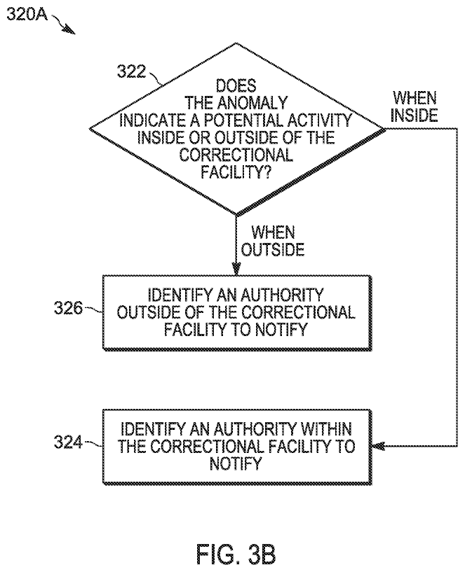

FIG. 3A is a flowchart illustrating selected elements of an example method 300 for detecting anomalies in a communication by an inmate and notifying an authority, in accordance with some embodiments. In at least some embodiments, some or all of the operations shown in FIG. 3A may be performed by an analysis engine, such as analysis engine 210. In at least some embodiments, the analysis engine may include a processor and memory for storing instructions that when loaded and executed by the processor may cause the processor to perform any of the operations illustrated in FIG. 3A. In other embodiments, the analysis engine 210 may include a hardware state machine or other electronic circuitry configured to perform one or more of the operations illustrated in FIG. 3A. While a particular order of operations is indicated in FIG. 3A for illustrative purposes, the timing and ordering of such operations may vary where appropriate without negating the purpose and advantages of the examples set forth in detail in this disclosure.

In this example embodiment, method 300 begins at block 302 in FIG. 3A and continues at block 304 with receiving a communication associated with an inmate in a correctional facility. In some embodiments, the communication may be received by an analysis engine, such as analysis engine 210 as described for FIG. 2, from a monitoring device, such as monitoring devices 230A, 230B, and 230C as described for FIG. 2. In some embodiments, the received communication may be a text representation of an inmate communication. In other embodiments, the received communication may be an audio file, a video file, or an image file, and the analysis engine may be configured to convert the audio file, video file, or image file to a text representation thereof. At block 306, the method includes evaluating a keyword identified within a text representation of the received communication using an anomaly detection model 308. Anomaly detection model 308 may be, for example, anomaly detection model 101 or 102 as described for FIG. 1. In some embodiments, machine-learning or other artificial intelligence techniques may be used to identify a keyword within the text representation of an inmate's communication. In some embodiments, string-matching or other similar techniques may be used to compare the text of an inmate's communication to the data included in the inmate's anomaly detection model to identify a keyword. In some embodiments, parameters may be associated with the general data and the inmate-specific data included in an inmate's anomaly detection model. The parameters may include, but are not limited to, point values, multiplication factors, and threshold values. In some embodiments, a parameter may provide, for example, a weight used in the evaluation of a keyword identified within an inmate communication. In some embodiments, an identified keyword may be evaluated by calculating a point value associated with the keyword. In some embodiments, evaluating an identified keyword may include assigning, by an analysis engine, a point value that may indicate the likelihood that a keyword represents an anomaly. A point value may also indicate a level of interest by an authority in potential activities associated with a keyword. The point value may be dependent on which anomaly detection model is used by the analysis engine.

At block 310, the method includes determining whether the identified keyword is an anomaly, which may also be referred to as determining whether to classify a keyword identified within a text representation of an inmate communication as an anomaly. In some embodiments, machine-learning or other artificial intelligence techniques may be used to make the determination. In some embodiments, a keyword may be classified as an anomaly when a parameter associated with the keyword, such as a point value, meets or exceeds a threshold value. Threshold values may be a parameter associated with certain data or groups of data included in an anomaly detection model. The threshold value may be the same for each inmate or it may vary for each inmate. For example, an inmate whose past behaviors indicate a relatively low risk of engaging in potential activities of interest (e.g., activities corresponding to crimes, safety issues, or both) may have a higher threshold value than another inmate whose past behaviors indicate a relatively high risk of engaging in potential activities of interest. As used herein, a keyword identified within an inmate communication may refer to a single keyword or a combination of keywords identified within the communication. In some embodiments, a combination of keywords may be assigned a parameter, such as a multiplication factor, based on the number of keywords identified within an inmate communication, the proximity of a keyword to another keyword, and the like.

As an example, a threshold value may be a predetermined value of 10 points. The word ‘drug’ may be a keyword identified within an inmate communication. In some embodiments, the word ‘drug’ may be included in an anomaly detection model, for example as general data. The word ‘drug’ may have an associated parameter, such as a weight value indicating a point value, for example a point value of 5. When no other keywords are identified within the inmate communication, the keyword may be evaluated as a 5 and determined not to be an anomaly because 5 does not meet or exceed the threshold value of 10. In this example scenario, the text representation of the inmate communication may be saved for future use, as indicated by block 312. In another example scenario, the word ‘drug’ may be classified as an anomaly based on the presence of another identified keyword and/or the proximity of another identified keyword to the word ‘drug’. In some embodiments, the word ‘smuggle’ may also be included in an anomaly detection model, for example as general data. The word ‘smuggle’ may have an associated parameter, such as a weight value indicating a point value, for example a point value of 6. In some embodiments, the keyword ‘drug’ may be evaluated based on the presence of both the keywords ‘drug’ and ‘smuggle’ identified within an inmate communication and may be given a cumulative point value of 11. In this scenario, the total evaluated point value of 11 associated with the keyword ‘drug,’ or alternatively the keyword ‘smuggle,’ exceeds the example predetermined threshold value of 10 points, and the keyword may be determined to be an anomaly. In this example scenario, the combination of keywords is an anomaly because it may indicate a potential criminal activity associated with the inmate, for example the potential smuggling of a drug.

In another example, the predetermined threshold value may be 15 points. The word ‘kill’ may be a keyword identified within an inmate communication. In some embodiments, the word ‘kill’ may be included in an anomaly detection model, for example, as general data. The word ‘kill’ may have an associated parameter, such as a weight value indicating a point value, for example a point value of 6. The name of a person associated with the inmate may be another keyword identified within the same inmate communication. For example, Bob Smith may be the name of a witness to a criminal offense that is associated with inmate, for example a criminal offense for which the inmate is incarcerated. As another example, Bob Smith may be the name of another inmate in the correctional facility. In some embodiments, the name of a witness may be included in an anomaly detection model, for example, as inmate-specific data. In some embodiments, a listing of the names of all of the inmates in a correctional facility may be included in an anomaly detection model, for example, as general data. In some embodiments, the name of an inmate's cell-mate may be included in an anomaly detection model, for example, as inmate-specific data. In the example scenario where Bob Smith is the name of a witness, the name Bob Smith may have an associated parameter, such as a weight value indicating a point value, for example a point value of 6. Further, an additional parameter, such as a multiplication factor, may be associated with the keyword ‘kill’ when the keyword ‘kill’ is identified, for example, within a predetermined range of a certain number of words of a witness name, within the same sentence as a witness name, or within the same inmate communication. For example, a multiplication factor parameter of 1.5 may be used. Although the evaluated cumulative point value of the word ‘kill’ and the name Bob Smith may be evaluated to be 12, which is less than the threshold value of 15, the application of the 1.5 multiplication factor may yield a total evaluated point value of 18. In this example scenario, the total evaluated point value of 18 associated with the keyword ‘kill,’ or alternatively the keyword ‘Bob Smith,’ exceeds the example predetermined threshold value of 15 points, and the keyword may be determined to be an anomaly. In this example scenario, the combination of keywords is an anomaly indicating a potential criminal activity associated with the inmate, for example the potential killing of the witness Bob Smith. In some embodiments, an anomaly indicating the potential killing of the witness Bob Smith may also represent a potential safety issue associated with the inmate.

In yet another example, the predetermined threshold value may be 10 points. The word ‘suicide’ may be a keyword identified within an inmate communication. In some embodiments, the word ‘suicide’ may be included in an anomaly detection model, for example, as general data. The word ‘suicide’ may have an associated parameter, such as a weight value indicating a point value, for example a point value of 15. In this scenario, the evaluated total point value of 15 associated with the keyword ‘suicide,’ exceeds the example predetermined threshold value of 10 points, and the keyword may be determined to be an anomaly. In this example scenario, the identified keyword is an anomaly indicating a potential safety issue associated with the inmate, for example, a potential attempted suicide by the inmate.

In response to determining that the keyword is anomaly, the method continues at block 314 with generating an alert for the anomaly. In some embodiments, the alert includes information about the evaluated keyword, the inmate with whom a potential activity is associated, the evaluation of the keyword, and the like. For example, an alert generated for an anomaly detected in a communication by Inmate A may include Inmate A's name and other information identifying Inmate A. The alert may also include the keyword, or multiple keywords when there are more than one, determined to be an anomaly. For example, when the keyword relates to the name of a witness or an officer associated with the inmate, the alert may include the name of the witness or officer. The alert may also include information related to the evaluation of the keyword, for example, an evaluated total point value associated with the keyword and the threshold value used in the determination to classify the keyword as an anomaly. In some embodiments, the alert may also include information regarding the level of risk associated with the detected anomaly. For example, an evaluated total point value may be used to indicate a level of risk associated with the detected anomaly. In some embodiments, the alert may also include all or a portion of the text representation of the inmate's communication, or it may include a link to a stored text representation of the communication.

The method continues at block 320 with determining an authority to notify. Timely notifying an appropriate authority may allow for the authority to intervene and prevent a potential activity indicated by the detected anomaly. Examples of appropriate authorities may include a pod officer within the correctional facility that is assigned to, or otherwise responsible for, an inmate, a peace officer outside of the correctional facility, such as a detective associated with an inmate, a prosecutor outside of the correctional facility, and the like. At block 330, the method includes notifying the determined authority with the generated alert. In some embodiments, the determined authority may be notified with a communication such as an email, a text message, or a telephone call. In some embodiments, a dedicated notification system may be used that notifies the determined authority using, for example, a web portal or other application using a web browser.

FIG. 3B is a flowchart illustrating selected elements of an example method 320A to determine an authority to notify that may be included within block 320 of FIG. 3A. At block 322, the method includes determining whether the detected anomaly indicates a potential activity inside or outside of the correctional facility in which the associated inmate is incarcerated. When inside, the method continues at block 324 with identifying an authority within the correctional facility to notify, such as a responsible pod officer. When outside, the method continues at block 326 with identifying an authority outside of the correctional facility to notify, such as a peace officer outside of the correctional facility. In some embodiments, there may be determined both an authority within the correctional facility and an authority outside of the correctional facility to notify. The method 320A for determining an authority to notify may be illustrated using, as examples, the above described example scenarios involving a potential drug smuggling crime, a potential killing of a witness, and a potential suicide attempt.

Considering the above example scenario where the presence of the keywords ‘drug’ and ‘smuggle’ in an inmate communication are determined to be an anomaly, the anomaly may indicate, for example, a potential crime of smuggling drugs into the inmate's correctional facility. In this example, method 320A for determining an authority to notify may proceed as follows. At block 322, the detected anomaly may be determined to indicate a potential criminal activity inside of the correctional facility, for example, the anomaly may indicate that the inmate is attempting or conspiring to have drugs smuggled into the correctional facility so that the inmate may use or sell the drugs within the correctional facility. At block 324, a pod officer responsible for the inmate may be identified as an appropriate authority within the correctional facility to notify. Once notified, the pod officer may be able to take actions to prevent the potential crime from occurring within the correctional facility. At block 322, the detected anomaly may also be determined to indicate a potential criminal activity outside of the correctional facility, for example, the anomaly may indicate that a person outside of the correctional facility is attempting or conspiring with the inmate to smuggle drugs into the correctional facility. At block 326, a peace officer or a prosecutor may be identified as an appropriate authority outside of the correctional facility to notify. In this example scenario, method 320A for determining an authority to notify may include identifying more than one authority and identifying authorities both within and outside of the correctional facility.

Considering the above example scenario where the presence of the keywords ‘kill’ and ‘Bob Smith’ (an example witness name) in an inmate communication are determined to be an anomaly, the anomaly may indicate the potential crime of killing the witness Bob Smith. In this example, method 320A for determining an authority to notify may proceed as follows. At block 322, the detected anomaly may be determined to indicate a potential criminal activity outside of the correctional facility. For example, the anomaly may indicate that the inmate is attempting or conspiring to have a witness to a criminal offense associated with the inmate killed. At block 326, a peace officer or a prosecutor may be identified as an appropriate authority outside of the correctional facility to notify. Once notified, the authority outside of the correctional facility may be able to take actions to prevent the potential crime from occurring outside of the correctional facility.

Considering the above example scenario where the presence of the keyword ‘suicide’ in an inmate communication is determined to be an anomaly, the anomaly may indicate the potential safety issue of a suicide attempt by the inmate. In this example, method 320A for determining an authority to notify may proceed as follows. At block 322, the detected anomaly may be determined to indicate a potential safety issue inside of the correctional facility, for example, the anomaly may indicate that the inmate is planning to commit suicide within the correctional facility. At block 324, a pod officer responsible for the inmate may be identified as an appropriate authority within the correctional facility to notify. Once notified, the pod officer may be able to take actions to prevent the potential safety issue from occurring within the correctional facility. In any of the above embodiments, a default authority may be pre-identified as an appropriate authority to notify such that determining an authority to notify may include identifying the default authority when no other appropriate authority is identified. In some embodiments, a default authority may be pre-identified as an appropriate authority that is always notified. A default authority may be the same for many or all inmates or it may be specific to each inmate. Examples of default authorities may include an authority within the correctional facility that is responsible for all inmate communication anomalies or a pod officer responsible for an individual inmate.

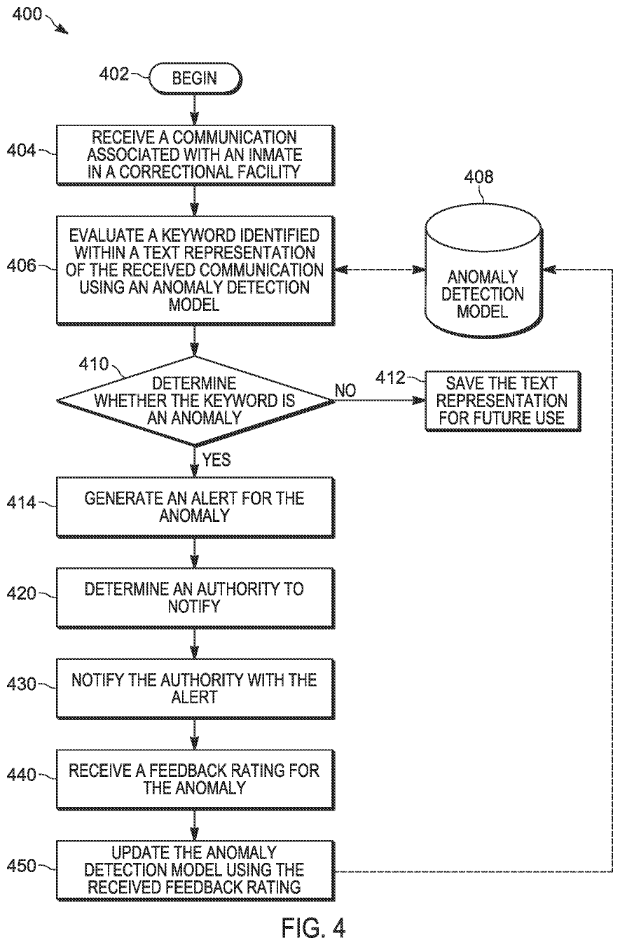

FIG. 4 is a flowchart illustrating selected elements of an example method 400 for detecting anomalies in a communication by an inmate, notifying an authority, receiving feedback for the anomaly, and updating the anomaly detection model using the received feedback, in accordance with some embodiments. In at least some embodiments, some or all of the operations shown in FIG. 4 may be performed by an analysis engine, such as analysis engine 210 as described for FIG. 2. In at least some embodiments, the analysis engine may include a processor and memory storing instructions that when loaded and executed by the processor cause the processor to perform any of the operations illustrated in FIG. 4. In other embodiments, the analysis engine may include a hardware state machine or other electronic circuitry configured to perform one or more of the operations illustrated in FIG. 4. While a particular order of operations is indicated in FIG. 4 for illustrative purposes, the timing and ordering of such operations may vary where appropriate without negating the purpose and advantages of the examples set forth in detail in this disclosure.

In this example embodiment, method 400 begins at block 402 in FIG. 4 and continues at block 404 with receiving a communication associated with an inmate in a correctional facility. Block 404 may be implemented in a similar manner as described for block 304 as described for FIG. 3A. At block 406, the method includes evaluating a keyword identified within a text representation of the received communication using an anomaly detection model 408. Block 406 and anomaly detection model 408 may be implemented in a similar manner as described for block 306 and anomaly detection model 308 as described for FIG. 3A. Anomaly detection model 408 may be, for example, anomaly detection model 101 or 102 as described for FIG. 1. At block 410, the method includes determining whether the keyword is an anomaly, which may also be referred to as determining whether to classify a keyword identified within a text representation of an inmate communication as an anomaly. Block 410 may be implemented in a similar manner as described for block 310 as described for FIG. 3A. When the keyword is determined not to be an anomaly, the text representation of the inmate communication may be saved for future use, as indicated by block 412. Block 412 may be implemented in a similar manner as described for block 312 as described for FIG. 3A. In response to determining that the keyword is anomaly, the method continues at block 414 with generating an alert for the anomaly. Block 414 may be implemented in a similar manner as described for block 314 as described for FIG. 3A. The method continues at block 420 with determining an authority to notify. Block 420 may be implemented in a similar manner as described for block 320 as described for FIG. 3A, which may include a similar method as method 320A as described for FIG. 3B. At block 430, the method includes notifying the determined authority with the generated alert. Block 430 may be implemented in a similar manner as described for block 330 as described for FIG. 3A.

Method 400 includes the additional operations at block 440 of receiving a feedback rating for the anomaly and block 450 of updating the anomaly detection model using the received feedback rating. In some embodiments, a feedback rating for the anomaly may be received at block 440 in response to notifying the authority with the alert at block 430. The received feedback rating may include, for example, an indication that the determination that the keyword is an anomaly from block 410 represents an accurate indication of a potential activity associated with the inmate. As another example, the received feedback rating may include, for example, an indication that the determination that the keyword is an anomaly from block 410 represents a false positive. A false positive may occur, for example, when an evaluated total point value for a keyword identified within an inmate communication is determined to exceed a threshold value, but where the determined anomaly does not indicate a potential activity of interest associated with the inmate. For example, an inmate may discuss the recent suicide of a family member with another family member outside of the correctional facility. Although the inmate communication may include the keyword suicide a number of times, upon further review it may be determined that there is no indication of a potential safety issue associated with the inmate. In some embodiments, the feedback rating may be received from the authority notified with the generated alert. For example, the generated alert may include a link allowing the notified authority to provide feedback regarding the accuracy of the determination that the identified keyword is an anomaly. As another example, the notified authority may be able to respond directly to the alert, such as by responding to an email alert or a text alert, with an indication of the accuracy of the determination that the identified keyword is an anomaly. In some embodiments, the feedback rating may be received from a person other than the notified authority that is responsible for reviewing generated alerts and rating the accuracy of the determination that an identified keyword is an anomaly.

The method continues at block 450 with updating the anomaly detection model using the received feedback rating. In some embodiments, the anomaly detection model, for example anomaly detection model 408 used in the evaluation of a keyword identified within an inmate communication at block 406, may be updated by adjusting a parameter of the anomaly detection model. In some embodiments, updating the anomaly detection model may include updating general data included in the anomaly detection model. In some embodiments, updating the anomaly detection model may include updating inmate-specific data included in the anomaly detection model. In some embodiments, machine-learning or other artificial intelligence techniques may be used to update an anomaly detection model. Updating the anomaly detection model may be illustrated using, as examples, the above described example scenarios involving a potential drug smuggling crime, a potential killing of a witness, and a potential suicide attempt.

Considering the above example scenario where the presence of the keywords ‘drug’ and ‘smuggle’ in an inmate communication are determined to be an anomaly, the anomaly may indicate, for example, a potential crime of smuggling drugs into the inmate's correctional facility. The notified authority, or alternatively another person, may review the generated alert and determine that the classification of the keyword as an anomaly was accurate. For example, a review of the text representation of the inmate communication may confirm that the inmate was indeed conspiring to smuggle drugs into the inmate's correctional facility. Based on a feedback rating for the anomaly received at block 440 indicating that the classification of the anomaly was accurate, the anomaly detection model may be updated. In some embodiments, a parameter associated with the words ‘drug’ and/or ‘smuggle’ may be adjusted. For example, the point value of 5 associated with the word ‘drug’ may be increased so that the word ‘drug’ is given more weight in the evaluation of other communications associated with the inmate. In some embodiments, a parameter may be adjusted for one inmate's anomaly detection model without adjusting a parameter for a different inmate's anomaly detection model, even when the parameter is associated with general data included in both inmates' anomaly detection models. In some embodiments, a parameter providing a threshold value may be adjusted. For example, the threshold value of 10 may be lowered so that a lower total point value for an evaluated keyword will be determined to be an anomaly. In some embodiments, an inmate's past criminal record or an inmate's history of incidents within a correctional facility may be used when updating the inmate's anomaly detection model. For example, when an inmate has a history of attempting to smuggle drugs into a correctional facility, a greater change in a parameter associated with the words ‘drug’ and/or ‘smuggle’ may be applied to account for a higher level of risk associated with the inmate for potential drug smuggling activities. In some embodiments, machine learning or other artificial intelligence techniques may be used to review an inmate's records to identify patterns and use that information in addition to a received feedback rating to update an inmate's anomaly detection model.

Considering the above example scenario in which the presence of the keywords ‘kill’ and ‘Bob Smith’ (an example witness name) in an inmate communication are determined to be an anomaly, the anomaly may indicate the potential crime of killing the witness Bob Smith. The notified authority, or alternatively another person, may review the generated alert and determine that the classification of the keyword as an anomaly was accurate. For example, a review of the text representation of the inmate communication may confirm that the inmate was soliciting the killing of Bob Smith. Based on a feedback rating for the anomaly received at block 440 indicating that the classification of the anomaly was accurate, the anomaly detection model may be updated. In some embodiments, a parameter providing a multiplication factor may be adjusted. For example, the multiplication factor of 1.5 associated with the word ‘kill’ when the word kill is within a certain proximity to a witness name, such as Bob Smith, may be increased. In some embodiments, data included in an inmate's anomaly detection model may be updated or a parameter of an inmate's anomaly detection model may be adjusted based on a received feedback rating for an anomaly indicating that the anomaly is a false positive. For example, a review of the generated alert may reveal that Bob Smith is not actually a witness to a criminal offense associated with the inmate. The inmate-specific data in the inmate's anomaly detection model may be updated to remove the name Bob Smith from the anomaly detection model.

Considering the example scenario where the presence of the keyword ‘suicide’ in an inmate communication is determined to be an anomaly, the anomaly may indicate the potential safety issue of a suicide attempt by the inmate. The notified authority, or alternatively another person, may review the generated alert and determine that the classification of the keyword as an anomaly was accurate. For example, a review of the text representation of the inmate communication may confirm that the inmate is contemplating suicide or is taking steps to commit suicide. In some embodiments, machine learning or other artificial learning techniques may be used to determine which parameter to adjust and how to adjust the parameter. In some embodiments, machine-learning techniques may be used to identify patterns in inmate communications and to determine how to update the inmate's anomaly detection model based, at least in part, on the identified patterns. For example, a machine-learning technique may detect a recent increase in the frequency of the word ‘suicide’ in communications associated with the inmate, which may indicate an increased risk for suicide associated with the inmate. The machine-learning technique may adjust a parameter, such as increasing the weight given to the word ‘suicide’ or decreasing a threshold value, based on the identified increase in frequency. In some embodiments, a parameter may be adjusted for multiple inmates' anomaly detection models. For example, a machine-learning technique may detect a pattern of an increase in anomalies associated with the keyword ‘suicide’ and may update the anomaly detection models of many or all inmates to increase a weight parameter associated with the word ‘suicide.’

In some embodiments, determining whether a keyword is an anomaly, for example at block 310 of FIG. 3A or block 410 of FIG. 4, may include determining, based on a first feedback rating associated with a first anomaly, whether the keyword is a second anomaly. For example, a feedback rating associated with a first anomaly may be used to update an inmate's anomaly detection model by, for example, adjusting a parameter associated with the keyword. In a subsequent second communication by the inmate, the updated anomaly detection model may be used to determine whether the keyword is a second anomaly. In this way, the accuracy of an anomaly detection system may be improved over time. In some embodiments, a first feedback rating associated with a first anomaly may be received and the anomaly detection model may be updated during the initial training of an anomaly detection system.

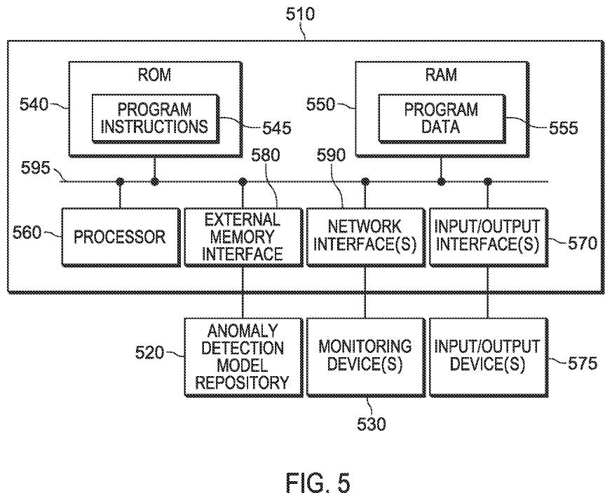

FIG. 5 is a block diagram illustrating selected elements of an analysis engine 510 of an anomaly detection system, in accordance with some embodiments. In some embodiments, analysis engine 510 may be implemented similar to analysis engine 210 as described for FIG. 2. In some embodiments, analysis engine 510 may be a machine-learning-based analysis engine that uses machine learning techniques to detect inmate communication anomalies. In the illustrated example, analysis engine 510 includes a Read Only Memory (ROM) 540, a Random Access Memory (RAM) 550, an electronic processor 560, one or more input/output device interfaces 570 for communicating with locally attached input/output devices 575, an external memory interface 580 through which analysis engine 510 may be coupled to an anomaly detection model repository 520, which may be stored in an external memory, and a network interface 590 through which analysis engine 510 receives inputs from various monitoring devices 530, all of which are coupled to a system bus 595 through which they communicate with each other. In some embodiments, monitoring devices 530 may be implemented similar to monitoring devices 230A, 230B, and 230C as described for FIG. 2. In some embodiments, at least some inputs may be received from particular monitoring devices 530 through one or more wired or wireless input/output interfaces 570. Input/output device interfaces 570 may include one or more analog input interfaces, such as one or more analog-to-digital (A/D) convertors, or digital interfaces for receiving signals or data from, and sending signals or data to, one or more input/output devices 575. For example, input/output device interfaces 570 and network interfaces 590 may include suitable interfaces for receiving audio inputs, video inputs, or text inputs.

In some embodiments, anomaly detection model repository 520 may be implemented similar to anomaly detection model repository 220 as described for FIG. 2. In various embodiments, an external memory in which anomaly detection model repository 520 is stored may include, for example, a database system, a hard-disk drive (HDD), an optical disk drive such as a compact disk (CD) drive or digital versatile disk (DVD) drive, a solid-state drive (SSD), a tape drive, or a flash memory drive, to name a few. In various embodiments, the electronic processor 560 may include a microprocessor, a microcontroller, a system-on-chip, a field-programmable gate array, a programmable mixed-signal array, or, in general, any system or sub-system that includes nominal memory and that is capable of loading and executing a sequence of instructions in order to control hardware. In some embodiments, the electronic processor 560 may include a hardware state machine or other electronic circuitry configured to perform one or more of the operations of the methods disclosed herein.

In the illustrated embodiment, ROM 540 stores program instructions 545, at least some of which may be loaded and executed by the electronic processor 560 to perform the methods described herein. For example, any or all of the operations of method 300 illustrated in FIG. 3 and method 400 illustrated in FIG. 4 may be performed by program instructions 545 executing on electronic processor 560 of analysis engine 510. In some embodiments, program instructions 545 may be stored in another type of non-volatile memory, such as a hard disk, a CD-ROM, an optical storage device, a magnetic storage device, a PROM (Programmable Read Only Memory), an EPROM (Erasable Programmable Read Only Memory), an EEPROM (Electrically Erasable Programmable Read Only Memory), or a Flash memory. In some embodiments, program instructions 545 may include program instructions that when loaded and executed by electronic processor 560 implement other functionality features of analysis engine 510. For example, program instructions 545 may include program instructions that when loaded and executed by electronic processor 560 cause the processor to generate a text representation of an inmate communication. As another example, program instructions 545 may include program instructions that when loaded and executed by electronic processor 560 cause the processor to identify a keyword within a text representation of an inmate communication.

In this example embodiment, RAM 550 may, from time to time, store program data 555 including, without limitation, information representing an anomaly detection model currently being used by analysis engine 510 to evaluate and determine whether an identified keyword is an anomaly, an input received from a monitoring device 530, a threshold value parameter for determining whether a keyword is an anomaly, an initial classification result for a given input, a final classification result for a given input, and/or other data accessible by program instructions 545 and used in performing the methods described herein. In some embodiments, some or all of the information used by analysis engine 510 may be stored in a programmable non-volatile memory, such as in an external memory communicatively coupled to analysis engine 510 through external memory interface 580.

In some embodiments, RAM 550 may also store data used in performing other functions of analysis engine 510. In some embodiments, RAM 550 may, from time to time, store local copies of all or a portion of program instructions 545 or other program instructions copied from ROM 540. In some embodiments, RAM 550 may, from time to time, store local copies of data copied from anomaly detection model repository 520 or another external memory over external memory interface 580.

In various embodiments, input/output device interfaces 570 and network interfaces 590 may operate to allow analysis engine 510 to receive user input, such as commands, feedback ratings, and other information usable to configure analysis engine 510 for detecting anomalies in inmate communications. User input may be provided, for example, via a keyboard or keypad, soft keys, icons, or soft buttons on a touch screen of a display, a smart phone, smart speaker, or other type of virtual assistant that provides voice input or video input based on voice recognition or gesture recognition, a scroll ball, a mouse, buttons, and the like (not shown in FIG. 5). In some embodiments, input/output device interfaces 570 may include a graphical user interface (GUI) generated, for example, by electronic processor 560 from program instructions 545 and program data 555 and presented on a display, enabling a user to interact with the display. Input/output device interfaces 570 may also include other input mechanisms, which for brevity are not described herein and which may be implemented in hardware, software, or a combination of both.

Network interfaces 590 may be a suitable system, apparatus, or device operable to serve as an interface between electronic processor 560 and a network. In some embodiments, network interface 590 may enable analysis engine 510 to communicate with a server or a remote device (not shown in FIG. 5) over a network using a suitable transmission protocol and/or standard, including, but not limited to, transmission protocols and/or standards enumerated below with respect to the discussion of the network. In some embodiments, network interface 590 may be communicatively coupled via a network to a network storage resource. The network may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data, and/or messages (generally referred to as data). The network may transmit data using a desired storage and/or communication protocol, including, but not limited to, Fibre Channel, Frame Relay, Asynchronous Transfer Mode (ATM), Internet Protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network and its various components may be implemented using hardware, software, or any combination thereof. In some embodiments, network interface 590 may enable wired and/or wireless communications to and/or from monitoring devices 530, an anomaly detection model repository, or other elements of an anomaly detection system that includes analysis engine 510.

In various embodiments, analysis engine 510 may include more, fewer, or different elements than those of analysis engine 510 illustrated in FIG. 5.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the terms are defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way but may also be configured in ways that are not listed or shown.

It will be appreciated that some embodiments may be comprised of one or more generic or specialized electronic processors (sometimes referred to as “processors” or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used.

Moreover, an embodiment can be implemented as a computer-readable storage medium having computer-readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of any single disclosed embodiment. Thus, the following claims are hereby incorporated into the Detailed Description, with each claim standing on its own as a separately claimed subject matter.

We claim:

1. A method for detecting inmate communication anomalies, comprising:
receiving a communication associated with an inmate in a correctional facility;
evaluating a keyword identified within a text representation of the received communication using an anomaly detection model;
determining whether the keyword is an anomaly based on the evaluation, wherein the anomaly indicates a potential activity associated with the inmate;
in response to determining that the keyword is an anomaly:
generating an alert for the anomaly;
determining an authority to notify; and
notifying the authority using the generated alert.

2. The method of claim 1, wherein the potential activity associated with the inmate corresponds to at least one of:
a crime; or
a safety issue.

3. The method of claim 1, further comprising:
receiving a feedback rating for the anomaly in response to notifying the authority using the generated alert; and
updating the anomaly detection model using the received feedback rating.

4. The method of claim 1, wherein the keyword is evaluated in real-time to an original transmission of the communication.

5. The method of claim 1, wherein determining an authority to notify comprises:
determining that the potential activity associated with the inmate relates to an activity outside of the correctional facility; and
identifying an authority outside of the correctional facility to notify.

6. The method of claim 1, wherein the anomaly detection model comprises inmate-specific data associated with the inmate.

7. The method of claim 6, wherein the inmate-specific data comprises at least one of:
a criminal record; or
a name of a person associated with a criminal offense, wherein the criminal offense is associated with the inmate.

8. The method of claim 6, wherein:
the anomaly detection model further comprises general data associated with a plurality of inmates; and
the plurality of inmates comprises the inmate.

9. The method of claim 3, wherein:
the anomaly detection model comprises a parameter providing a weight for the evaluation; and
updating the anomaly detection model using the received feedback rating comprises adjusting the parameter of the anomaly detection model.

10. The method of claim 9, wherein:
the anomaly detection model further comprises inmate-specific data associated with the inmate; and
the parameter is associated with the inmate-specific data.

11. The method of claim 9, wherein:
the anomaly detection model further comprises general data associated with a plurality of inmates;
the plurality of inmates comprises the inmate; and
the parameter is associated with the general data.

12. A system for detecting inmate communication anomalies, comprising:
a monitoring device to capture a communication by an inmate in a correctional facility;
a non-volatile memory to store an anomaly detection model;
an analysis engine communicatively coupled to the non-volatile memory, the analysis engine comprising:
a first input to receive the captured communication from the monitoring device;
a processor configured to:
evaluate a keyword identified within a text representation of the communication, the evaluation using the anomaly detection model;
determine whether the keyword is an anomaly based on the evaluation, wherein the anomaly indicates a potential activity associated with the inmate;
in response to determining that the keyword is an anomaly:
generate an alert for the anomaly;
determine an authority to notify;
notify the authority using the generated alert; and
an output to notify the authority.

13. The system of claim 12, wherein the potential activity associated with the inmate corresponds to at least one of:
a crime; or
a safety issue.

14. The system of claim 12, wherein:
the analysis engine further comprises a second input to receive a feedback rating for the anomaly in response to notifying the authority using the generated alert; and
the processor is further configured to update the anomaly detection model using the received feedback rating.

15. The system of claim 12, wherein the anomaly detection model comprises inmate-specific data associated with the inmate.

16. The system of claim 15, wherein the inmate-specific data comprises at least one of:
a criminal record; or
a name of a person associated with a criminal offense, wherein the criminal offense is associated with the inmate.

17. The system of claim 15, wherein:
the anomaly detection model further comprises general data associated with a plurality of inmates; and
the plurality of inmates comprises the inmate.

18. The system of claim 14, wherein:
the anomaly detection model comprises a parameter providing a weight for the evaluation; and
the processor is further configured to adjust the parameter of the anomaly detection model.

19. The system of claim 18, wherein:
the anomaly detection model further comprises inmate-specific data associated with the inmate; and
the parameter is associated with the inmate-specific data.

20. A non-transitory, computer-readable storage medium having program instructions stored thereon that when loaded and executed by an electronic processor cause the electronic processor to perform:
evaluating a keyword identified within a text representation of a communication associated with an inmate in a correctional facility using an anomaly detection model;
determining whether the keyword is an anomaly based on the evaluation, wherein the anomaly indicates a potential activity associated with the inmate;
in response to determining that the keyword is an anomaly:
generating an alert for the anomaly;
determining an authority to notify; and
notifying the authority using the generated alert.
